(19) United States
(12) Patent Application Publication
(10) Pub. No.: US 2015/0039914 A1
(43) Pub. Date: Feb. 5, 2015

(54) APPARATUS AND METHOD FOR ESTIMATING POWER CONSUMPTION

(71) Applicant: Electronics and Telecommunications Research Institute, Daejeon (KR)

(72) Inventors: Byeong Thaek Oh, Daejeon (KR); SungIk Jun, Daejeon (KR); Baik Song An, Seoul (KR); Byung-gyu Lee, Daejeon (KR)

(21) Appl. No.: 14/448,325

(22) Filed: Jul. 31, 2014

(30) Foreign Application Priority Data
Aug. 5, 2013 (KR) 10-2013-0092739

(51) Int. Cl. G06F 1/32

(52) U.S. Cl. CPC G06F 1/3209
USPC 713/300

(57) ABSTRACT

A power consumption estimation apparatus searches for an accessory apparatus that is mounted in a computing system that is connected through the Internet, receives a power consumption value of the accessory apparatus and a correlation value on an accessory apparatus combination basis from a power consumption and load amount information providing server, and estimates power consumption of the computing system using the power consumption value of the accessory apparatus and the correlation value on an accessory apparatus combination basis.

### CROSS-REFERENCE TO RELATED APPLICATION

This application claims priority to and the benefit of Korean Patent Application No. 10-2013-0092739 filed in the Korean Intellectual Property Office on Aug. 5, 2013, the entire contents of which are incorporated herein by reference.

### BACKGROUND OF THE INVENTION

(a) Field of the Invention

The present invention relates to a method and apparatus for estimating power consumption. More particularly, the present invention relates to a method and apparatus for estimating power consumption for estimating power that an on-line computing apparatus consumes and provides the estimated power value to a user.

(b) Description of the Related Art

As energy use increases according to the trend of high performance and large capacity of an IT system as well as a personal computer system, a power consumption amount in the IT field continuously increases, compared with a stated consumption amount of a manufacturing industry field. Interest has increased in energy reduction technologies of the IT field due to such a reason, and energy reduction technology of an IT system representatively includes low power design technology. Low power design technology is widely used in hardware design with peak power minimization technology and power leakage minimization technology, and low power hardware is considered to be an essential element thereof.

However, as an example, when a user enables a vehicle that is designed to have good fuel consumption to have output that is substantially higher than that of the vehicle norm, the fuel consumption amount cannot be reduced, and similarly, it is difficult to achieve power reduction of a computer system by only using a computer with a low power hardware design.

Further, in order for a user to recognize a power consumption amount of a computer system like fuel consumption claims of a vehicle, when using a power measurement apparatus in the computer system, an accurate power use amount value can be obtained, but there are actually many computer systems in which the power measurement apparatus is not mounted, and even if the power measurement apparatus is mounted, power consumption of the computer system may further increase due to power measurement, and when continuously measuring power consumption of each component, operation overhead occurs and thus performance of the computer system may be deteriorated.

### SUMMARY OF THE INVENTION

The present invention has been made in an effort to provide a method and apparatus for estimating power consumption having advantages of estimating power consumption of a computer system without mounting a power measurement apparatus in the computer system, and providing the estimated power consumption to the user.

An exemplary embodiment of the present invention provides an apparatus that estimates power consumption of a computing system that is connected through the Internet. The power consumption estimation apparatus includes an apparatus search processor and an estimator. The apparatus search processor searches for an accessory apparatus that is mounted in the computing system. The estimator receives a power consumption value of the accessory apparatus from a power consumption and load amount information providing server that is connected through the Internet, and estimates power consumption of the computing system using the power consumption value of the accessory apparatus.

The power consumption estimation apparatus may further include an application program search processor. The application program search processor may search for an application program that is installed in the computing system. The estimator may receive workload information of the application program from the power consumption and load amount information providing server, and estimate power consumption of the computing system using the power consumption value of the accessory apparatus and the workload information of the application program.

The estimator may receive a correlation value on an accessory apparatus combination basis from the power consumption and load amount information providing server, and apply the correlation value on an accessory apparatus combination basis to the power consumption value of the accessory apparatus.

The power consumption estimation apparatus may further include a user interface. The user interface may receive use time information and a priority order of an application program according to a use amount from a user. The estimator may calculate a power consumption estimation value of an application program of the computing system using the workload information and a use time of each application program according to the priority order.

The estimator may recognize a model and a platform of the computing system, receive an entire power consumption value corresponding to the model and platform information from the power consumption and load amount information providing server, and verify a power consumption estimation value of the computing system through comparing with the entire power consumption value.

Another embodiment of the present invention provides a method of estimating power consumption of a computing system that is connected through the Internet in a power consumption estimation apparatus. The method includes: searching for an application program that is installed in the computing system; searching for an accessory apparatus that is mounted in the computing system; receiving a power consumption value of the accessory apparatus and workload information of the application program from a power consumption and load amount information providing server that is connected through the Internet;

and estimating entire power consumption of the computing system using the power consumption value of the accessory apparatus and the workload information of the application program.

The estimation of entire power consumption may include calculating a power consumption estimation value of an entire accessory apparatus of the computing system by applying a correlation value on a corresponding accessory apparatus combination basis to the sum of power consumption values of the accessory apparatus; calculating a power consumption estimation value of the application program of the computing system using workload information of the application program; and calculating an entire power consumption estimation value of the computing system by adding the power consumption estimation value of the entire accessory apparatus of the computing system and the power consumption estimation value of the application program.

The receiving of a power consumption value may include receiving the correlation value on an accessory apparatus combination basis from the power consumption and load amount information providing server.

The calculating of a power consumption estimation value may include receiving a priority order and use time information of the application program according to a use amount from the user, and calculating a power consumption estimation value of an application program of the computing system using a use time and workload information of each application program according to the priority order.

The method may further include verifying an entire power consumption estimation value of the computing system.

The verifying of an entire power consumption estimation value may include: recognizing a model and a platform of the computing system; receiving an entire power consumption value corresponding to the model and platform information from the power consumption and load amount information providing server; and verifying the entire power consumption estimation value of the computing system through comparison with the received entire power consumption value.

### BRIEF DESCRIPTION OF THE DRAWINGS

FIG. 1 is a diagram illustrating a power consumption estimation target according to an exemplary embodiment of the present invention.

FIG. 2 is a block diagram illustrating a configuration of a power consumption estimation apparatus according to an exemplary embodiment of the present invention.

FIG. 3 is a flowchart illustrating a method of estimating power consumption in a power consumption estimation apparatus according to an exemplary embodiment of the present invention.

FIG. 4 is a flowchart illustrating a method of estimating a power consumption value in an estimator according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for estimating power consumption according to an exemplary embodiment of the present invention will be described in detail with reference to the drawings.

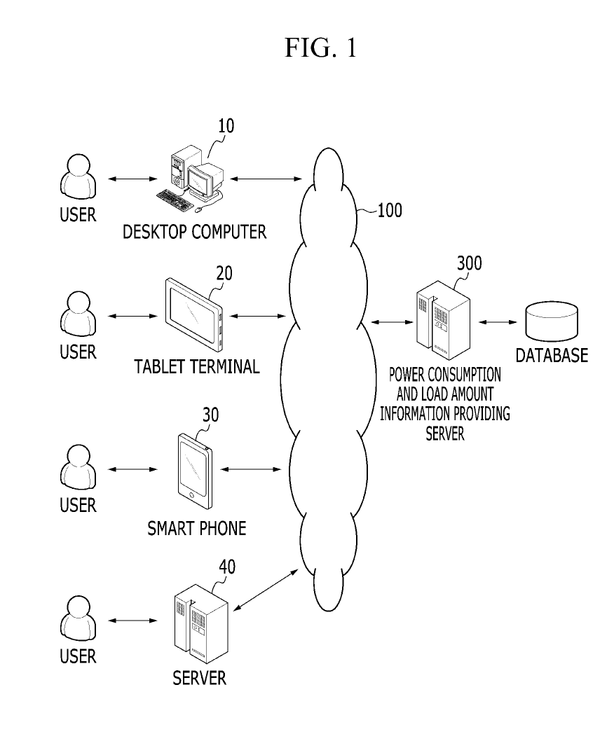

FIG. 1 is a diagram illustrating a power consumption estimation target according to an exemplary embodiment of the present invention.

Referring to FIG. 1, a power consumption estimation target may include a desktop computer 10, a tablet terminal 20, a mobile communication terminal 30 such as a smart phone, and a server 40 that are connected through the Internet 100.

A power consumption estimation apparatus receives power consumption amount information corresponding to a model of power consumption estimation targets (hereinafter referred to as a “computing system”) 10, 20, 30, and 40 that are connected through the Internet 100, power consumption amount information of each accessory apparatus, and workload information of an application program that is installed in the computing system (10, 20, 30, and 40) from a power consumption and load amount information providing server 300 to estimate power consumption of the computing system (10, 20, 30, and 40), and provides the estimated power consumption of the power consumption estimation target to a user.

Such a power consumption estimation apparatus may be embodied in each component of the user's computing system (10, 20, 30, and 40). Alternatively, the power consumption estimation apparatus may be embodied in a separate server. When a power consumption estimation apparatus 200 is embodied in the server, a power consumption estimation service provider receives the users subscription to charge a power consumption estimation service and provides the power consumption estimation service to the user.

The power consumption and load amount information providing server 300 stores power consumption amount information of a computing system model, power consumption amount information on an accessory apparatus basis, workload information of each application program, and use amount information of each accessory apparatus. In the workload information, load information on a component basis of each computer system, such as a CPU, a memory, a network, and I/O, may be included.

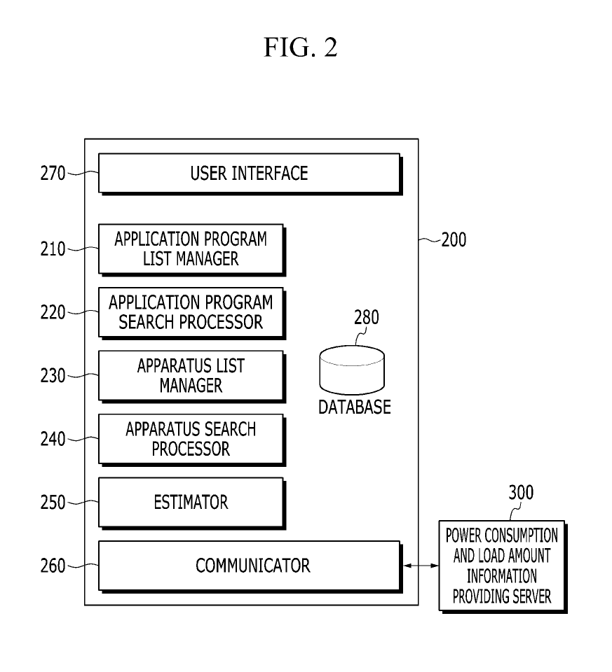

FIG. 2 is a block diagram illustrating a configuration of a power consumption estimation apparatus according to an exemplary embodiment of the present invention.

Referring to FIG. 2, the power consumption estimation apparatus 200 includes an application program list manager 210, an application program search processor 220, an apparatus list manager 230, an apparatus search processor 240, an estimator 250, a communicator 260, a user interface 270, and a database 280.

The application program list manager 210 manages a list of application programs that are installed in the user's computing system (e.g., 10 of FIG. 1).

The application program search processor 220 searches for an application program that is installed in the computing system 10.

The apparatus list manager 230 manages a list of accessory apparatuses (e.g., components) that are mounted in the computing system 10.

The apparatus search processor 240 searches for an accessory apparatus that is mounted in the computing system 10.

The estimator 250 requests power consumption amount information corresponding to a model of the computing system 10, power consumption amount information of each accessory apparatus, and workload information of an application program that is installed in the computing system 10 from the power consumption and load amount information providing server 300, and receives this information from the power consumption and load amount information providing server 300.

The estimator 250 estimates power consumption of the computing system 10 using the power consumption amount information corresponding to a model of the computing system 10, the power consumption amount information of each accessory apparatus, use amount information of each accessory apparatus, and the workload information of an application program. For example, hardware resource use amounts of a Microsoft Word program and a motion picture editing program such as Premier are different and thus power consumption is different. Therefore, when using load information on each application program basis, power consumption corresponding to an application program may be estimated.

Further, when the estimator 250 receives a power consumption inquiry request of the computing system 10 from the user through the user interface 270, the estimator 250 may provide a power consumption estimation value of the computing system 10 to the user through the user interface 270.

The communicator 260 communicates with the power consumption and load amount information providing server 300. The user interface 270 provides an interface between the user and the power consumption estimation apparatus 200.

The database 280 stores information generated in the power consumption estimation apparatus 200. For example, in the database 280, a power consumption estimation value of the computing system 10 and list information of accessory apparatuses that are mounted in the computing system 10 or list information of an application program may be stored. Further, in the database 280, power consumption amount information corresponding to a model of the computing system 10 that is received from the power consumption and load amount information providing server 300, power consumption amount information of each accessory apparatus, and workload information of an application program may be stored.

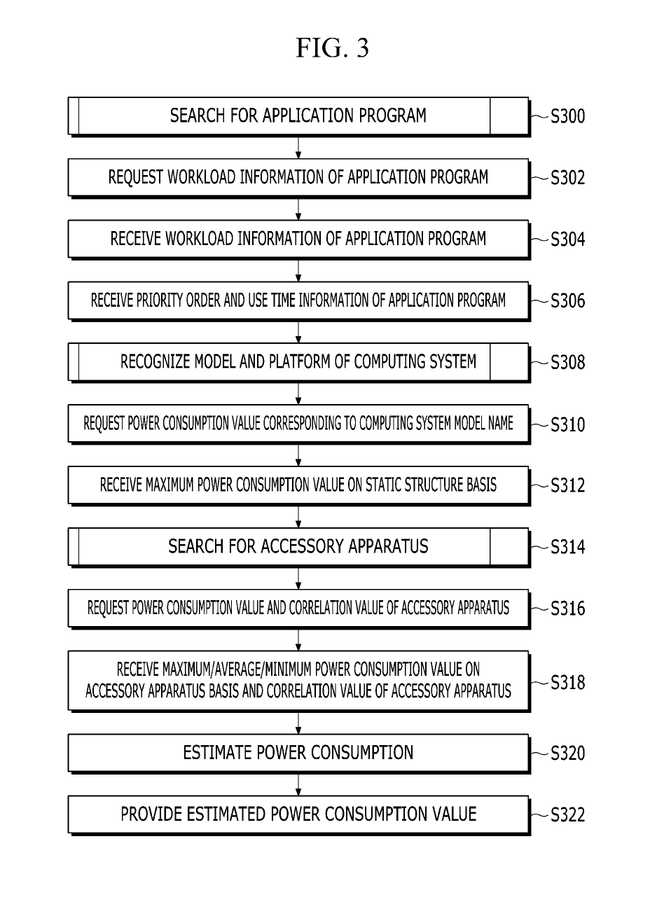

FIG. 3 is a flowchart illustrating a method of estimating power consumption in a power consumption estimation apparatus according to an exemplary embodiment of the present invention. Referring to FIG. 3, when a user drives the power consumption estimation apparatus 200, the application program search processor 220 of the power consumption estimation apparatus 200 searches for an application program that is installed in a corresponding computing system (S300). In this method, the reason for searching for the application program is that power consumption is different according to an application program that is operated in the computing system.

The application program search processor 220 provides a list of found application programs to the user through the user interface 270. The estimator 250 of the power consumption estimation apparatus 200 requests workload information of the found application programs from the power consumption and load amount information providing server 300 (S302), and receives the workload information of the found application programs from the power consumption and load amount information providing server 300 (S304).

The user selects a priority order of frequently used application programs. In this step, the user can additionally select an approximate use time of each application program.

The user interface 270 of the power consumption estimation apparatus 200 receives a priority order of an application program from the user and use time information of the application program (S306), and transfers the priority order of the application program that is received from the user and use time information of the application program to the estimator 250. In this case, in order to rapidly estimate power consumption, the step of searching for application programs (S300), the steps of requesting and receiving workload information of the found application program from the power consumption and load amount information providing server 300 (S302 and S304), and the step of receiving a priority order and use time information of the application program (S306) may be omitted by the user's selection.

Next, the estimator 250 of the power consumption estimation apparatus 200 recognizes a model and a platform of a corresponding computing system (S308).

The estimator 250 requests an entire power consumption value of a corresponding computing system model from the power consumption and load amount information providing server 300 through the Internet based on a model name and platform information of the recognized computing system (S310), and receives a maximum power consumption value on a static structure basis corresponding to the corresponding computing system model name from the power consumption and load amount information providing server 300 (S312). The static structure indicates a fixed model such as a computer system of a finished product. Therefore, the maximum power consumption value on a static structure basis is a power value that a computer system maximally consumes on a model basis when an accessory apparatus configuration of the computer system is already initially determined and is formed in a system of one model.

Further, the apparatus search processor 240 of the power consumption estimation apparatus 200 searches for an accessory apparatus of the computing system (S314). In this case, because some or the entirety of accessory apparatuses in the computer system may have been replaced with another accessory apparatus model, the apparatus search processor 240 searches for the accessory apparatus.

The estimator 250 requests a power consumption value of the found accessory apparatus and a correlation value on a combination basis of the accessory apparatus from the power consumption and load amount information providing server 300 through the Internet 100 (S316), and receives a maximum/average/minimum power consumption value on an accessory apparatus basis and a correlation value on an accessory apparatus combination basis from the power consumption and load amount information providing server 300 (S318).

The estimator 250 estimates a power consumption value of a computing system using a maximum power consumption value on a static structure basis corresponding to a model name of a corresponding computing system, a list of the found application programs, a use time of the application programs, a power consumption value of the found accessory apparatuses, and a correlation value of the accessory apparatuses, received from the power consumption and load amount information providing server 300 (S320).

Finally, the estimator 250 provides a power consumption estimation value of the corresponding computing system to the user through the user interface 270 (S322).

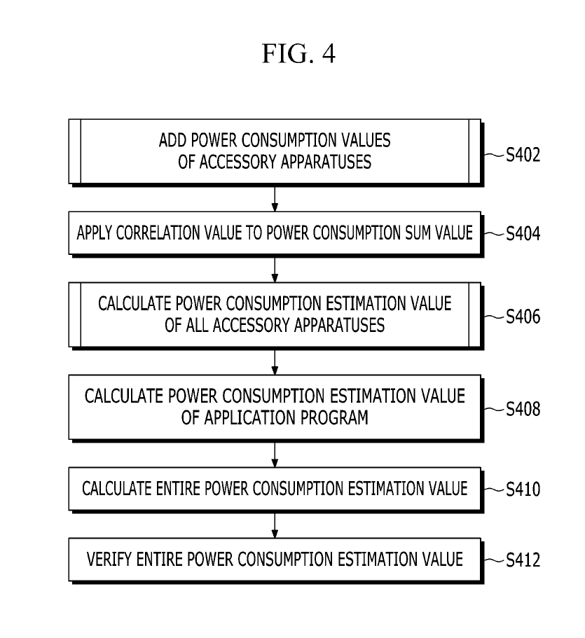

FIG. 4 is a flowchart illustrating a method of estimating a power consumption value in an estimator according to an exemplary embodiment of the present invention.

Referring to FIG. 4, when the estimator 250 receives a power consumption value of each accessory apparatus from the power consumption and load amount information providing server 300 and a correlation value on an accessory apparatus combination basis, the estimator 250 adds the power consumption values of each accessory apparatus (S402).

Further, the estimator 250 calculates a power consumption estimation value of all accessory apparatuses of a computing system by applying a correlation value on an accessory apparatus combination basis corresponding to a power consumption sum value (S404-S406). In a corresponding computer system in which some or all of the accessory apparatuses are replaced with other accessory apparatus models, when a power consumption value of any accessory apparatus assembled together with any other of several accessory apparatuses is determined, power consumption values may be different because of compatibility and overall efficiency differences, and thus when simply calculating entire power consumption of accessory apparatuses of a computer system, entire power consumption is not calculated with only a method of adding power consumption of each accessory apparatus, and by reflecting a correlation value to the power consumption sum value, a more accurate power consumption estimation value can be obtained.

Next, when the estimator 250 receives a priority order and a use time of an application program from the user, the estimator 250 calculates a power consumption estimation value of an application program of a computing system using use time and workload information of the application program according to the priority order (S408).

The estimator 250 adds a power consumption estimation value of all accessory apparatuses of the computing system and a power consumption estimation value of an application program of the computing system and calculates an entire power consumption estimation value (S410), and compares and verifies the entire power consumption estimation value with a maximum power consumption value that is received from the power consumption and load amount information providing server 300 through step S312 of FIG. 3 (S412).

According to an exemplary embodiment of the present invention, by enabling a user to recognize a power consumption amount of a computer system, when the user selects or uses a computer system, power consumption can be reduced in consideration of power consumption.

A computer system designer or a computer system production company can previously estimate a power consumption amount on a static structure basis by inquiring from a power consumption amount related DB of existing computer systems.

Further, even when a user replaces a computer system component with a low power component with information that is estimated through a method and apparatus that are present in an exemplary embodiment of the present invention, updated power consumption estimation information can be obtained online, and by using a computer system of a specification corresponding to a presently operating application program without using a high-end computer system, a power reduction effect can be obtained.

When a computer system designer or a computer system production company selects a power providing apparatus (PSU) through power budget estimation, by analyzing a power influence to enable power not to be wasted or to be insufficient, an optimal apparatus may be selected, and when adding a new apparatus to a computer system, an entire power consumption amount change can be estimated. Furthermore, standby power of a computer system can be estimated using a method and apparatus according to an exemplary embodiment of the present invention.

Further, a method of comparing a user computer system based on a power consumption amount can be used.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus that estimates power consumption of a computing system that is connected through the Internet, the apparatus comprising:
an apparatus search processor that searches for an accessory apparatus that is mounted in the computing system; and
an estimator that receives a power consumption value of the accessory apparatus from a power consumption and load amount information providing server that is connected through the Internet, and that estimates power consumption of the computing system using the power consumption value of the accessory apparatus.

2. The apparatus of claim 1, further comprising an application program search processor that searches for an application program that is installed in the computing system,
wherein the estimator receives workload information of the application program from the power consumption and load amount information providing server, and estimates power consumption of the computing system using the power consumption value of the accessory apparatus and the workload information of the application program.

3. The apparatus of claim 2, wherein the estimator receives a correlation value on an accessory apparatus combination basis from the power consumption and load amount information providing server, and applies the correlation value on an accessory apparatus combination basis to the power consumption value of the accessory apparatus.

4. The apparatus of claim 3, wherein the estimator calculates a power consumption estimation value of an application program of the computing system using the workload information of the application program, calculates a power consumption estimation value of an entire accessory apparatus of the computing system using the power consumption value of the accessory apparatus and the correlation value on an accessory apparatus combination basis, and estimates power consumption of the computing system by adding the power consumption estimation value of the entire accessory apparatus of the computing system and the power consumption estimation value of the application program.

5. The apparatus of claim 2, further comprising a user interface that receives use time information and a priority order of an application program according to a use amount from a user,
wherein the estimator calculates a power consumption estimation value of an application program of the computing system using workload information and a use time of each application program according to the priority order.

6. The apparatus of claim 2, wherein the estimator recognizes a model and a platform of the computing system, receives an entire power consumption value corresponding to the model and platform information from the power consumption and load amount information providing server, and verifies a power consumption estimation value of the computing system through comparing with the entire power consumption value.

7. The apparatus of claim 1, further comprising a user interface that provides a power consumption estimation value of the computing system to the user.

8. A method of estimating power consumption of a computing system that is connected through the Internet in a power consumption estimation apparatus, the method comprising:
searching for an application program that is installed in the computing system;
searching for an accessory apparatus that is mounted in the computing system;
receiving a power consumption value of the accessory apparatus and workload information of the application program from a power consumption and load amount information providing server that is connected through the Internet; and
estimating entire power consumption of the computing system using the power consumption value of the accessory apparatus and the workload information of the application program.

9. The method of claim 8, wherein the estimation of entire power consumption comprises:
calculating a power consumption estimation value of an entire accessory apparatus of the computing system by applying a correlation value on a corresponding accessory apparatus combination basis to the sum of power consumption values of the accessory apparatus;
calculating a power consumption estimation value of the application program of the computing system using workload information of the application program; and
calculating an entire power consumption estimation value of the computing system by adding the power consumption estimation value of the entire accessory apparatus of the computing system and the power consumption estimation value of the application program.

10. The method of claim 9, wherein the receiving of a power consumption value comprises receiving the correlation value on an accessory apparatus combination basis from the power consumption and load amount information providing server.

11. The method of claim 9, wherein the calculating of a power consumption estimation value comprises:
receiving a priority order and use time information of the application program according to a use amount from the user; and
calculating a power consumption estimation value of an application program of the computing system using a use time and workload information of each application program according to the priority order.

12. The method of claim 8, further comprising providing an entire power consumption estimation value of the computing system to the user through the user interface.

13. The method of claim 8, further comprising verifying an entire power consumption estimation value of the computing system.

14. The method of claim 13, wherein the verifying of an entire power consumption estimation value comprises:
recognizing a model and a platform of the computing system;
receiving an entire power consumption value corresponding to the model and platform information from the power consumption and load amount information providing server; and
verifying the entire power consumption estimation value of the computing system through comparison with the received entire power consumption value.
